(19) United States
(12) Patent Application Publication
(10) Pub. No.: US 2018/0257478 A1
(43) Pub. Date: Sep. 13, 2018

(54) HYBRID ELECTRIC POWERTRAIN CONFIGURATIONS WITH A BALL VARIATOR CONTINUOUSLY VARIABLE TRANSMISSION USED AS A POWERSPLIT

(71) Applicant: DANA LIMITED, MAUMEE, OH (US)

(72) Inventors: RAYMOND J. HAKA, BRIGHTON, MI (US); KRISHNA KUMAR, HOLLAND, OH (US); ROBERT A. SMITHSON, LEANDER, TX (US); STEVEN J. WESOLOWSKI, WATERVILLE, OH (US); JAMES F. ZIECH, KALAMAZOO, MI (US)

(73) Assignee: DANA LIMITED, MAUMEE, OH (US)

(21) Appl. No.: 15/760,647

(22) PCT Filed: Sep. 16, 2016
(86) PCT No.: PCT/US2016/052140

§ 371 Date: Mar. 16, 2018

Related U.S. Application Data
(60) Provisional application No. 62/220,016, filed on Sep. 17, 2015.
(60) Provisional application No. 62/268,287, filed on Dec. 16, 2015.
(60) Provisional application No. 62/280,524, filed on Jan. 19, 2016.

(51) Int. Cl. B60K 6/543; B60K 6/442; B60K 6/365; F16H 15/50

(52) U.S. Cl. CPC B60K 6/543; B60K 6/442; B60K 6/365; Y10S 903/918; B60Y 2200/92; B60Y 2400/72; F16H 15/503

(57) ABSTRACT

Regular torque split planetary gear trains for automotive hybrid powertrains are limited by the fixed ratio of the planetary gear train. A powertrain incorporating a continuously variable transmission using a torque split with variable ratios enables the powertrain to use the ideal operating lines (IOL) of the engine, electric motor and generator along with the high voltage battery charge/discharge paths, depending upon the mode of operation (charge sustain or charge deplete modes) of the hybrid powertrain. A powertrain further equipped with a hybrid supervisory controller that chooses the torque split and path of highest efficiency from engine to wheel, can operate at the best potential overall efficiency point in any mode and also provide torque variability, thereby leading to the best combination of powertrain performance and fuel efficiency. Embodiments of powertrain configurations that can improve the efficiency of hybrid vehicles are discussed herein.

### CROSS-REFERENCES TO RELATED APPLICATIONS

The present application claims the benefit of U.S. Provisional Patent Application No. 62/220,016, filed Sep. 17, 2015; U.S. Provisional Patent Application No. 62/268,287, filed Dec. 16, 2015; and U.S. Provisional Patent Application No. 62/280,524, filed Jan. 19, 2016, which applications are incorporated herein by reference.

### BACKGROUND OF THE INVENTION

Hybrid vehicles are enjoying increased popularity and acceptance due in large part to the cost of fuel for internal combustion engine vehicles. Such hybrid vehicles include both an internal combustion engine as well as an electric motor to propel the vehicle.

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed gear ratio of the hybrid vehicle design.

### SUMMARY OF THE INVENTION

These hybrid vehicle designs, however, have encountered several disadvantages. One disadvantage is that, since the ratio between the electric motor/generator rotary shaft and the internal combustion engine main shaft is fixed, e.g. 3 to 1, the electric motor/generator is rotatably driven at high speeds during a high speed revolution of the internal combustion engine. For example, in the situations where the ratio between the electric motor/generator rotary shaft and the internal combustion engine main shaft is 3 to 1, if the internal combustion engine is driven at a high revolutions per minute of, e.g. 5,000 rpm, the electric motor/generator unit is driven at a rotation three times that amount, i.e. 15,000 rpm. Such high speed revolution of the electric motor/generator thus necessitates the use of expensive components, such as the bearings and brushes, to be employed to prevent damage to the electric motor/generator during such high speed operation.

A still further disadvantage of these hybrid vehicles is that the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that can improve the efficiency of hybrid vehicles.

Regular torque split planetary gear trains for automotive hybrid powertrains are limited by the fixed ratio of the planetary gear train. A powertrain incorporating a continuously variable transmission (CVT) using a planetary torque split with variable ratios enables the powertrain to use the ideal operating lines (IOL) of the engine, electric motor and generator along with the high voltage battery charge/discharge paths, depending upon the mode of operation (charge sustain or charge deplete modes) of the hybrid powertrain. A powertrain further equipped with a hybrid supervisory controller that chooses the path of highest efficiency from engine to wheel, can operate at the best potential overall efficiency point in any mode and also provide torque variability, thereby leading to the best combination of powertrain performance and fuel efficiency that can exceed current industry standards in the light vehicle segment.

Provided herein is a powertrain comprising: at least one motor/generator; a source of rotational power; a continuously variable planetary transmission having a plurality of balls, each ball provided with a tiltable axis of rotation, each ball in contact with first and second traction rings, each ball in contact with a sun, the sun located radially inward of each ball, and each ball operably coupled to a carrier, the carrier operably coupled to a shift actuator; wherein the source of rotational power is operably coupled to the first traction ring; wherein the sun is adapted to rotate freely; and wherein the first motor/generator is operably coupled to the second traction ring. In some embodiments of the powertrain, the carrier is operably coupled to a second motor/generator. In some embodiments of the powertrain, a brake is operably coupled to the second traction ring. In some embodiments of the powertrain, a first clutch is operably coupled to the second motor/generator. In some embodiments of the powertrain, a first clutch is operably coupled to the second motor/generator, and a second clutch operably coupled to the first motor/generator. In some embodiments of the powertrain, a first clutch is operably coupled to the first traction ring, a second clutch operably coupled to the second motor/generator, and a third clutch operably coupled to the first motor/generator. In some embodiments of the powertrain, a ball-ramp actuator is operably coupled to the first traction ring. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: a first motor/generator; a second motor/generator; a source of rotational power; a continuously variable planetary transmission having a plurality of balls, each ball provided with a tiltable axis of rotation, each ball in contact with first and second traction rings, each ball in contact with a sun, the sun located radially inward of each ball, and each balls operably coupled to a carrier, the carrier operably coupled to a shift actuator; wherein the source of rotational power is operably coupled to the carrier; wherein the first traction ring is adapted to rotate freely; and wherein the first motor/generator is operably coupled to the second traction ring. In some embodiments of the powertrain, the sun is operably coupled to the second motor/generator. In some embodiments of the powertrain, a brake is operably coupled to the second traction ring. In some embodiments of the powertrain, a first clutch is operably coupled to the second motor/generator. In some embodiments of the powertrain, a first clutch is operably coupled to the second motor/generator, and a second clutch operably coupled to the first motor/generator. In some embodiments of the powertrain, a first clutch is operably coupled to the first traction ring, a second clutch operably coupled to the second motor/generator, and a third clutch operably coupled to the first motor/generator. In some embodiments of the powertrain, a ball-ramp actuator is operably coupled to the first traction ring. In some embodiments of the powertrain, a first clutch is operably coupled to the first traction ring, a second clutch operably coupled to the second motor/generator, and a third clutch operably coupled to the first motor/generator. In some embodiments of the powertrain, a ball-ramp actuator is operably coupled to the first traction ring. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: a first motor/generator; a second motor/generator; a source of rotational power; a continuously variable planetary transmission having a plurality of balls, each ball provided with a tiltable axis of rotations, each ball in contact with first and second traction rings, each ball in contact with a sun, the sun located radially inward of each ball, and each balls operably coupled to a carrier, the carrier operably coupled to a shift actuator; wherein the source of rotational power is operably coupled to the first traction ring; wherein the carrier is adapted to rotate freely; and wherein the first motor/generator is operably coupled to the sun. In some embodiments of the powertrain, the second traction ring is operably coupled to the second motor/generator. In some embodiments of the powertrain, a brake operably is coupled to the second traction ring. In some embodiments of the powertrain, a first clutch is operably coupled to the second motor/generator. In some embodiments of the powertrain, a first clutch is operably coupled to the second motor/generator, and a second clutch operably coupled to the first motor/generator. In some embodiments of the powertrain, a first clutch is operably coupled to the first traction ring, a second clutch operably coupled to the second motor/generator, and a third clutch operably coupled to the first motor/generator. In some embodiments of the powertrain, a ball-ramp actuator is operably coupled to the first traction ring. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: at least one hydro-mechanical component; a source of rotational power; a continuously variable planetary transmission having a plurality of balls, each ball provided with a tiltable axis of rotation, each ball in contact with first and second traction rings, each ball in contact with a sun, the sun located radially inward of each ball, and each ball operably coupled to a carrier, the carrier operably coupled to a shift actuator; wherein the source of rotational power is operably coupled to the first traction ring; wherein the sun is adapted to rotate freely; and wherein the hydro-mechanical component is operably coupled to the second traction ring. In some embodiments of the powertrain, the carrier is operably coupled to a second hydro-mechanical component. In some embodiments of the powertrain, a brake is operably coupled to the second traction ring. In some embodiments of the powertrain, a first clutch is operably coupled to the second hydro-mechanical component. In some embodiments of the powertrain, a first clutch is operably coupled to the second hydro-mechanical component, and a second clutch operably coupled to the hydro-mechanical component. In some embodiments of the powertrain, a first clutch operably is coupled to the first traction ring, a second clutch operably coupled to the second hydro-mechanical component, and a third clutch operably coupled to the first hydro-mechanical component. In some embodiments of the powertrain, a ball-ramp actuator operably is coupled to the first traction ring. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: a first motor/generator; a second motor/generator; a source of rotational power; a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator; wherein the source of rotational power is operably coupled to the first traction ring; wherein the carrier is adapted to rotate freely; wherein the first motor/generator is operably coupled to the sun; and wherein the second motor/generator is operably coupled to the second traction ring; and wherein the CVP, the first motor/generator, the second motor/generator, and the source of rotational power are coaxial.

Provided herein is a powertrain comprising: a first motor/generator; a second motor/generator; a source of rotational power; a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator; wherein the source of rotational power is operably coupled to the first traction ring; wherein the carrier is adapted to rotate; wherein the first motor/generator is operably coupled to the carrier; and wherein the second motor/generator is operably coupled to the second traction ring; and wherein the CVP, the first motor/generator, the second motor/generator, and the source of rotational power are coaxial.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a hybrid powerpath having a planetary gear system.

FIG. 5 is another schematic diagram of a hybrid powerpath having a planetary gear system.

FIG. 6 is a schematic diagram of a series parallel hybrid dual motor architecture having a ball planetary transmission, two motor/generators, and an engine.

FIG. 7 is another schematic diagram of a series parallel hybrid dual motor architecture having a ball planetary transmission, two motor/generators, and an engine.

FIG. 8 is another schematic diagram of a series parallel hybrid dual motor architecture having a ball planetary transmission, two motor/generators, and an engine.

FIG. 9 is another schematic diagram of a series parallel hybrid dual motor architecture having a ball planetary transmission, two motor/generators, and an engine.

FIG. 10 is a schematic diagram of a series parallel hybrid dual motor architecture having a ball planetary transmission, two motor/generators, an engine, a brake element, and a clutch element.

FIG. 11 is another schematic diagram of a series parallel hybrid dual motor architecture having a ball planetary transmission, two motor/generators, an engine, a brake element, and a clutch element.

FIG. 12 is a schematic diagram of a series parallel hybrid dual motor architecture having a ball planetary transmission, two motor/generators, an engine, a brake element, and two clutch elements.

FIG. 13 is a schematic diagram of a series parallel hybrid dual motor architecture having a ball planetary transmission, two motor/generators, an engine, a brake element, and two clutch elements.

FIG. 14 is another schematic diagram of a series parallel hybrid dual motor architecture having a ball planetary transmission, two motor/generators, an engine, a brake element, and three clutch elements.

FIG. 15 is another schematic diagram of a series parallel hybrid dual motor architecture having a ball planetary transmission, two motor/generators, an engine, a brake element, and two clutch elements.

FIG. 16 is a schematic diagram of a series parallel hybrid dual motor architecture having a ball planetary transmission, two motor/generators, an engine, and a ball-ramp actuator.

FIG. 17 is another schematic diagram of a series parallel hybrid dual motor architecture having a ball planetary transmission, two motor/generators, an engine, and a ball-ramp actuator.

FIG. 18 is another schematic diagram of a series parallel hybrid dual motor architecture having a ball planetary transmission, two motor/generators, an engine, and a ball-ramp actuator.

FIG. 19 is another schematic diagram of a series parallel hybrid architecture having a ball planetary transmission, two motor/generators, an engine, and a ball-ramp actuator.

FIG. 20 is a schematic diagram of a series parallel hybrid dual motor architecture having a ball planetary transmission, two motor/generators, an engine, a brake element, a clutch element, and a ball-ramp actuator.

FIG. 21 is another schematic diagram of a series parallel hybrid dual motor architecture having a ball planetary transmission, two motor/generators, an engine, a brake element, a clutch element, and a ball-ramp actuator.

FIG. 22 is a schematic diagram of a series parallel hybrid dual motor architecture having a ball planetary transmission, two motor/generators, an engine, a brake element, two clutch elements, and a ball-ramp actuator.

FIG. 23 is another schematic diagram of a series parallel hybrid dual motor architecture having a ball planetary transmission, two motor/generators, an engine, a brake element, two clutch elements, and a ball-ramp actuator.

FIG. 24 is a schematic diagram of a series parallel hybrid dual motor architecture having a ball planetary transmission, two motor/generators, an engine, a brake element, three clutch elements, and a ball-ramp actuator.

FIG. 25 is another schematic diagram of a series parallel hybrid dual motor architecture having a ball planetary transmission, two motor/generators, an engine, a brake element, two clutch elements, and a ball-ramp actuator.

FIG. 26 a schematic diagram of a series parallel hybrid dual motor architecture having a ball planetary transmission, two motor/generators, and an engine.

FIG. 27 is another schematic diagram of a series parallel hybrid dual motor architecture having a ball planetary transmission, two motor/generators, and an engine.

FIG. 28 is another schematic diagram of a series parallel hybrid dual motor architecture having a ball planetary transmission, two motor/generators, and an engine.

FIG. 29 is yet another schematic diagram of a series parallel hybrid dual motor architecture having a ball planetary transmission, two motor/generators, and an engine.

FIG. 30 is schematic diagram of a series parallel hybrid dual motor architecture having a ball planetary transmission, two motor/generators, an engine, a brake element, and a clutch element.

FIG. 31 is another schematic diagram of a series parallel hybrid dual motor architecture having a ball planetary transmission, two motor/generators, an engine, a brake element, and a clutch element.

FIG. 32 is a schematic diagram of a series parallel hybrid dual motor architecture having a ball planetary transmission, two motor/generators, an engine, a brake element, and two clutch elements.

FIG. 33 is a schematic diagram of a series parallel hybrid dual motor architecture having a ball planetary transmission, two motor/generators, an engine, a brake element, and two clutch elements.

FIG. 34 is another diagram of a series parallel hybrid dual motor architecture having a ball planetary transmission, two motor/generators, an engine, a brake element, and three clutch elements.

FIG. 35 is another schematic diagram of a series parallel hybrid dual motor architecture having a ball planetary transmission, two motor/generators, an engine, a brake element, and two clutch elements.

FIG. 36 is another schematic diagram of a series parallel hybrid dual motor, dual clutch architecture having a ball planetary transmission, two motor/generators, an engine, and two clutch elements.

FIG. 37 is yet another schematic diagram of a series parallel hybrid dual motor, dual clutch architecture having a ball planetary transmission, two motor/generators, an engine, and two clutch elements.

FIG. 38 is yet another schematic diagram of a series parallel hybrid dual motor, dual clutch architecture having a ball planetary transmission, two motor/generators, an engine, and two clutch elements.

FIG. 39 is yet another schematic diagram of a series parallel hybrid dual motor, dual clutch architecture having a ball planetary transmission, two motor/generators, an engine, and two clutch elements.

FIG. 40 is a schematic diagram of a series parallel hybrid dual motor architecture having a ball planetary transmission, two motor/generators, an engine, two clutch elements, and an ball-ramp actuator.

FIG. 41 is another schematic diagram of a series parallel hybrid dual motor architecture having a ball planetary transmission, two motor/generators, an engine, two clutch elements, and a ball-ramp actuator.

FIG. 42 is a schematic diagram of a hybrid architecture having a ball planetary transmission, two motor/generators, and an engine configured for a rear wheel drive vehicle.

FIG. 43 is another schematic diagram of a hybrid architecture having a ball planetary transmission, two motor/generators, and an engine configured for a rear wheel drive vehicle.

### DETAILED DESCRIPTION OF THE INVENTION

These hybrid vehicle designs, however, have encountered several disadvantages. One disadvantage is that, since the ratio between the electric motor/generator rotary shaft and the internal combustion engine main shaft is fixed, for example, 3 to 1, the electric motor/generator is rotatably driven at high speeds during a high speed revolution of the internal combustion engine. For example, in the situations where the ratio between the electric motor/generator rotary shaft and the internal combustion engine main shaft is 3 to 1, if the internal combustion engine is driven at high revolutions per minute of, e.g. 5,000 rpm, the electric motor/generator unit is driven at a rotation three times that amount, i.e. 15,000 rpm. Such high speed revolution of the electric motor/generator thus necessitates the use of expensive components, such as the bearings and brushes, to be employed to prevent damage to the electric motor/generator during such high speed operation.

A still further disadvantage of these hybrid vehicles is that the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that can improve the efficiency of hybrid vehicles.

Regular torque split planetary gear trains for automotive hybrid powertrains are limited by the fixed ratio of the planetary gear train. A powertrain incorporating a continuously variable transmission using a planetary torque split with variable ratios enables the powertrain to use the ideal operating lines (IOL) of the engine, electric motor and generator along with the high voltage battery charge/discharge paths, depending upon the mode of operation (charge sustain or charge deplete modes) of the hybrid powertrain. A powertrain further equipped with a hybrid supervisory controller that chooses the path of highest efficiency from engine to wheel, can operate at the best potential overall efficiency point in any mode and also provide torque variability, thereby leading to the best combination of powertrain performance and fuel efficiency that can exceed current industry standards in the light vehicle segment.

Provided herein are powertrain configurations and architectures that are used in hybrid vehicles. The powertrain and/or drivetrain configurations used a ball planetary style continuously variable transmission, such as the VariGlide®, in order to couple power sources used in a hybrid vehicle, for example, combustion engines (internal or external), motors, generators, batteries, and gearing.

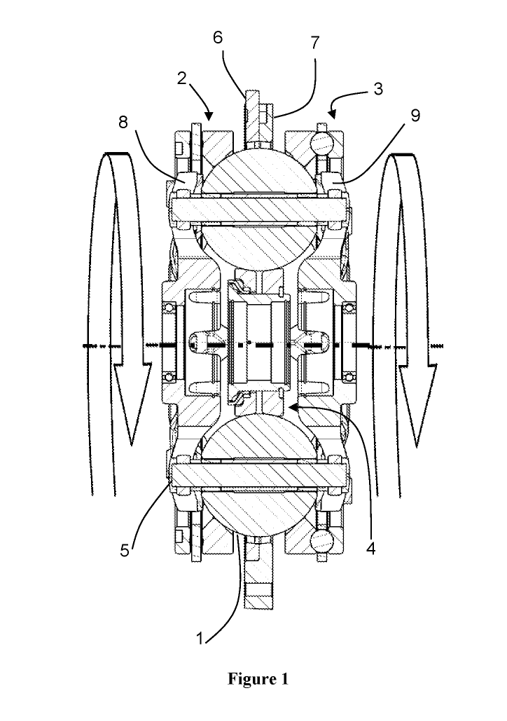

A typical ball planetary variator CVT design, such as that described in U.S. Pat. No. 8,066,614 and in U.S. Pat. No. 8,469,856, both incorporated herein by reference, in their entirety, represents a rolling traction drive system, transmitting forces between the input and output rolling surfaces through shearing of a thin fluid film. The technology is called Continuously Variable Planetary (CVP) due to its analogous operation to a planetary gear system. The system consists of an input disc (ring) driven by the power source, an output disc (ring) driving the CVP output, a set of balls fitted between these two discs and a central sun, as illustrated in FIG. 1. The balls are able to rotate around their own respective axle by the rotation of two carrier disks at each end of the set of ball axles. The system is also referred to as the Ball-Type Variator.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention include several novel features, no single one of which is solely responsible for its desirable attributes or which is essential to practicing the inventions described.

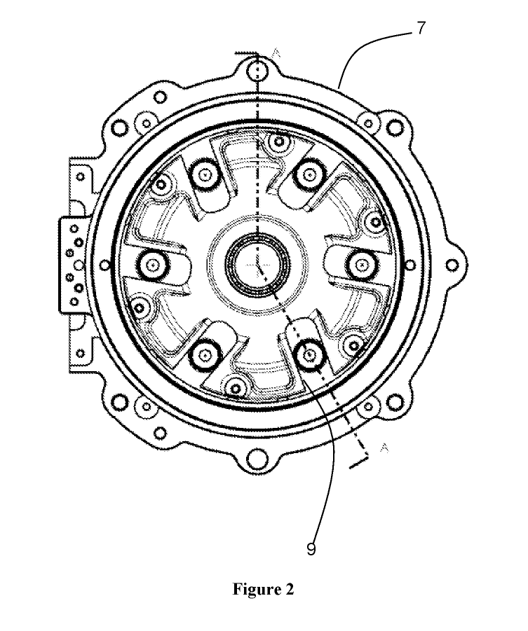

Provided herein are configurations of CVTs based on a ball type variators, also known as CVP, for continuously variable planetary. Basic concepts of a ball type Continuously Variable Transmissions are described in previously described U.S. Pat. No. 8,469,856 and also in U.S. Pat. No. 8,870,711, incorporated herein by reference in their entirety. Such a CVT, adapted herein as described throughout this specification, comprises a number of balls (planets, spheres) 1, depending on the application, two ring (disc) assemblies with a conical surface contact with the balls, as input 2 and output 3, and an idler (sun) assembly 4 as shown on FIG. 1. Sometimes, the input ring 2 is referred to in illustrations and referred to in text by the label “R1”. The output ring is referred to in illustrations and referred to in text by the label “R2”. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7 (FIG. 2). Sometimes, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9 (FIG. 2). The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

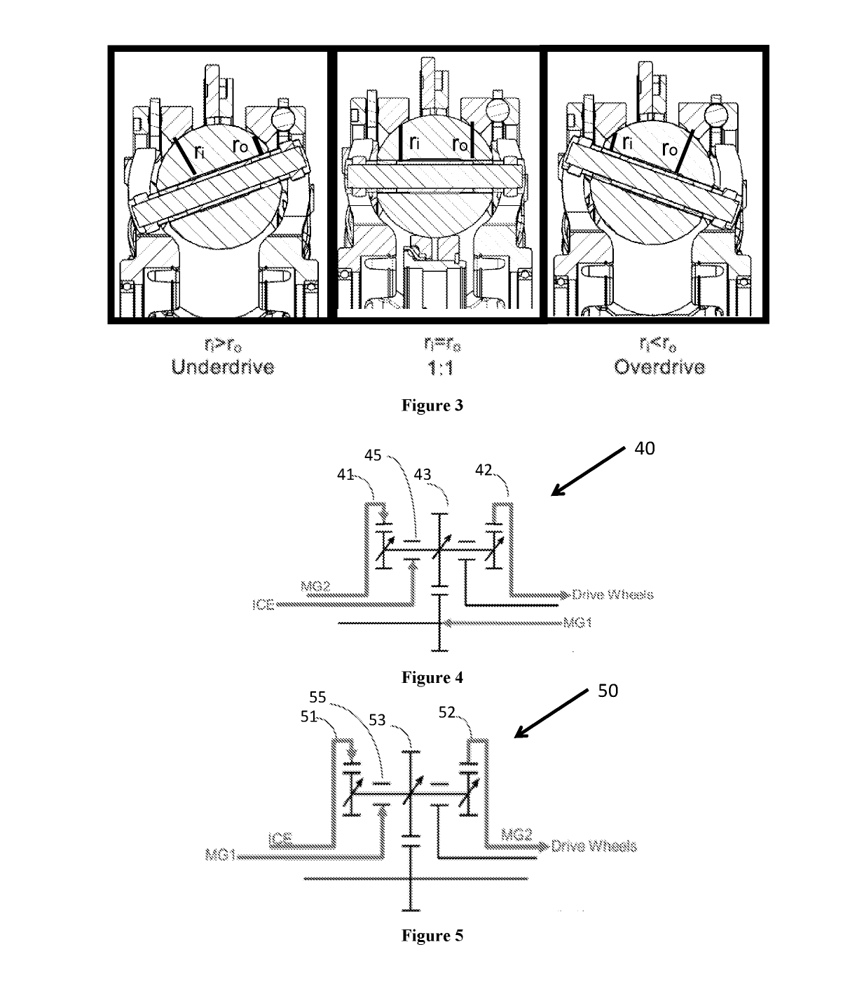

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 20.0 degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees, 0.08 degrees, 0.07 degrees, 0.06 degrees, 0.05 degrees, 0.04 degrees, 0.03 degrees, 0.02 degrees or 0.01 degrees of a given value or range.

As used herein, the terms “comprises”, “comprising”, or any other variation thereof, are intended to cover a nonexclusive inclusion, such that a process, method, article, or apparatus that comprises a list of elements does not include only those elements but may include other elements not expressly listed or inherent to such process, method, article, or apparatus.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, a control piston 123A and a control piston 123B) will be referred to collectively by a single label (for example, control pistons 123).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here could operate in both tractive and frictional applications. For example, in the embodiment where a CVT is used for a bicycle application, the CVT can operate at times as a friction drive and at other times as a traction drive, depending on the torque and speed conditions present during operation.

Referring now to FIG. 4, in some embodiments, a hybrid vehicle is configured with a planetary powerpath with a fixed ratio planetary powertrain 40, comprising a first ring (R1) 41, a second ring (R2) 42, a sun (S) 43, and a carrier (C) 45 that provides an internal combustion engine (ICE) with a high inertia powerpath while providing speed multiplication to a first motor/generator (“MG1” or “M/G 1”). A second motor/generator (“MG2” or “M/G 2”) is adapted to react to the ICE under driving conditions.

Passing to FIG. 5, in some embodiments, a hybrid vehicle is configured with a planetary powerpath with a fixed ratio planetary powertrain 50, comprising a first ring (R1) 51, a second ring (R2) 52, a sun (S) 53, and a carrier (C) 55 that provides the first motor/generator (MG1) with a high inertia powerpath that reacts to an ICE under driving conditions.

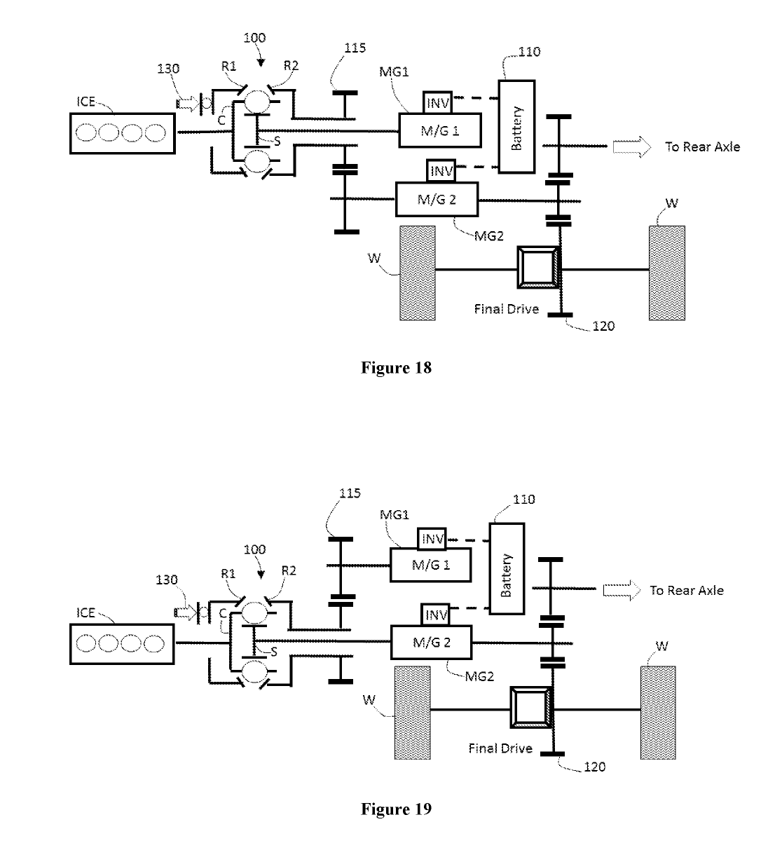

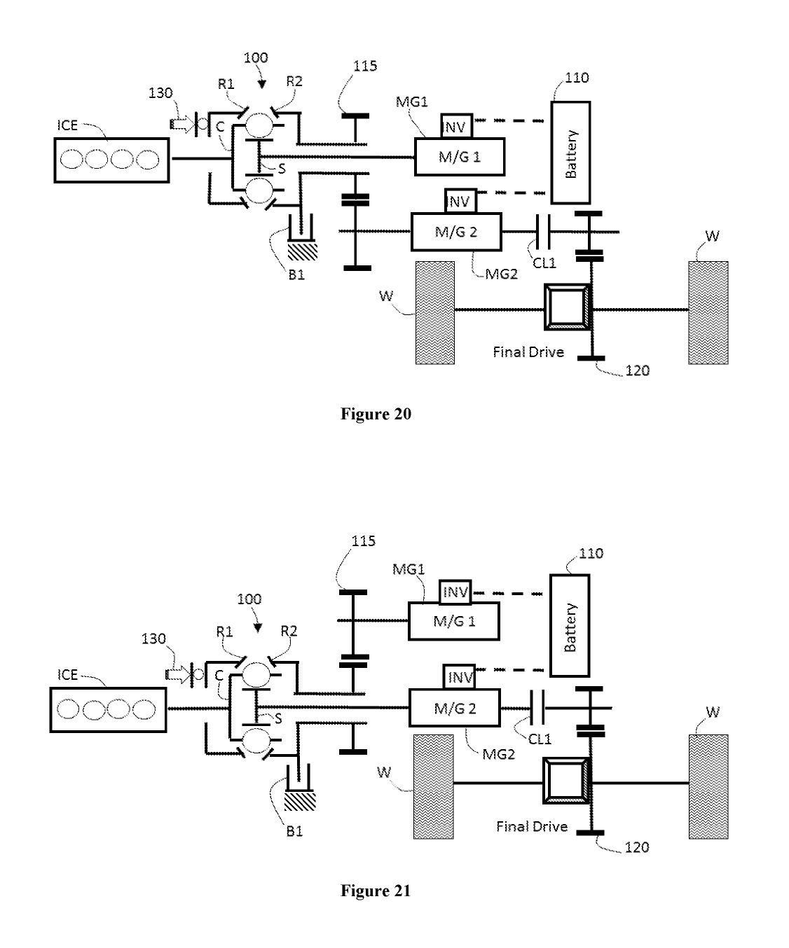

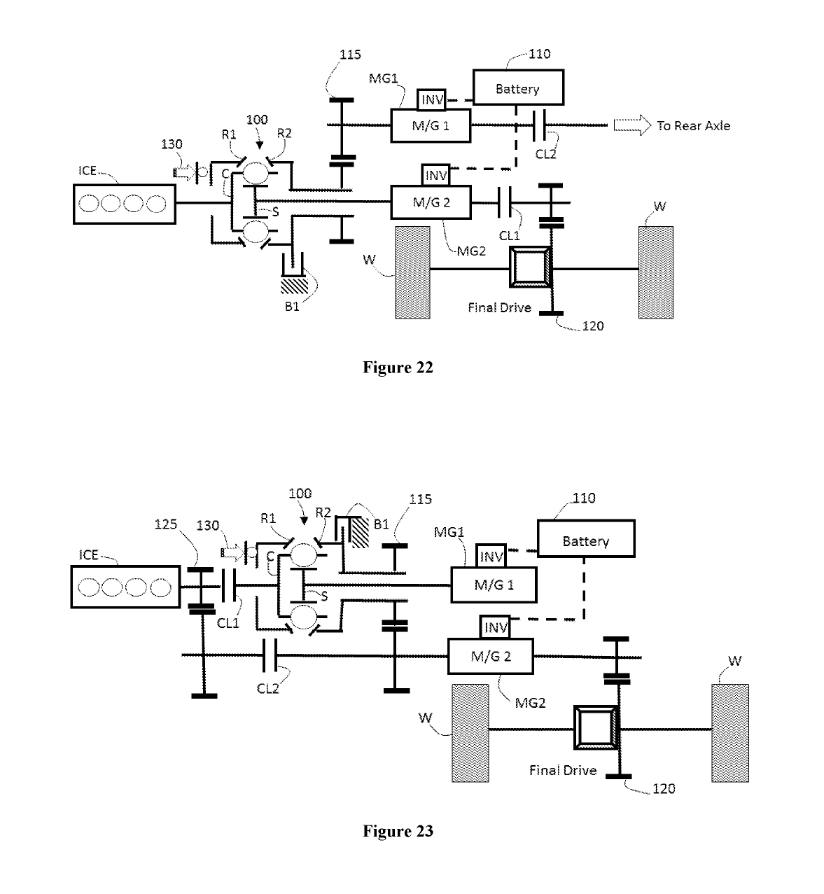

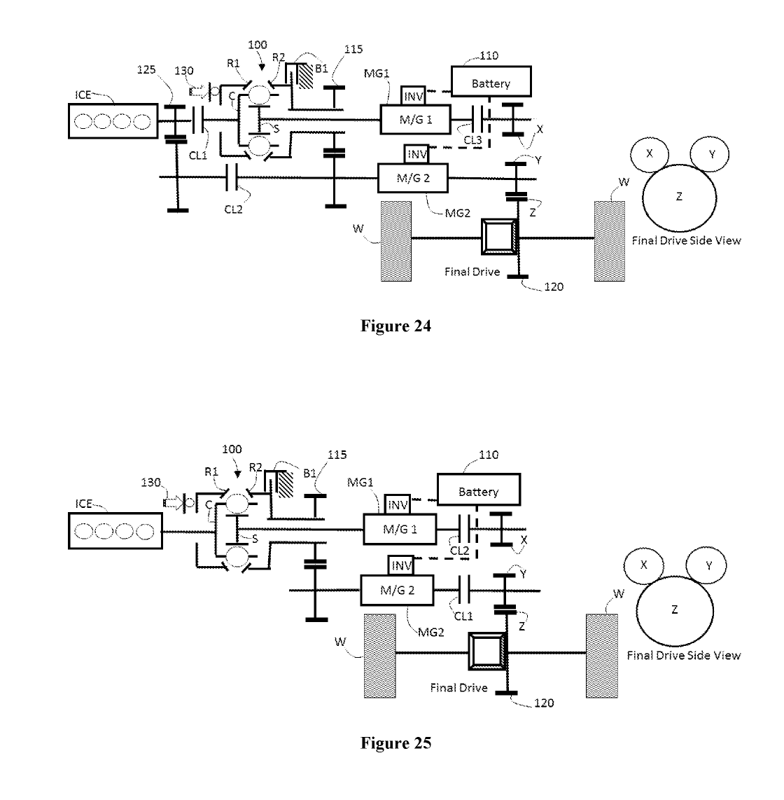

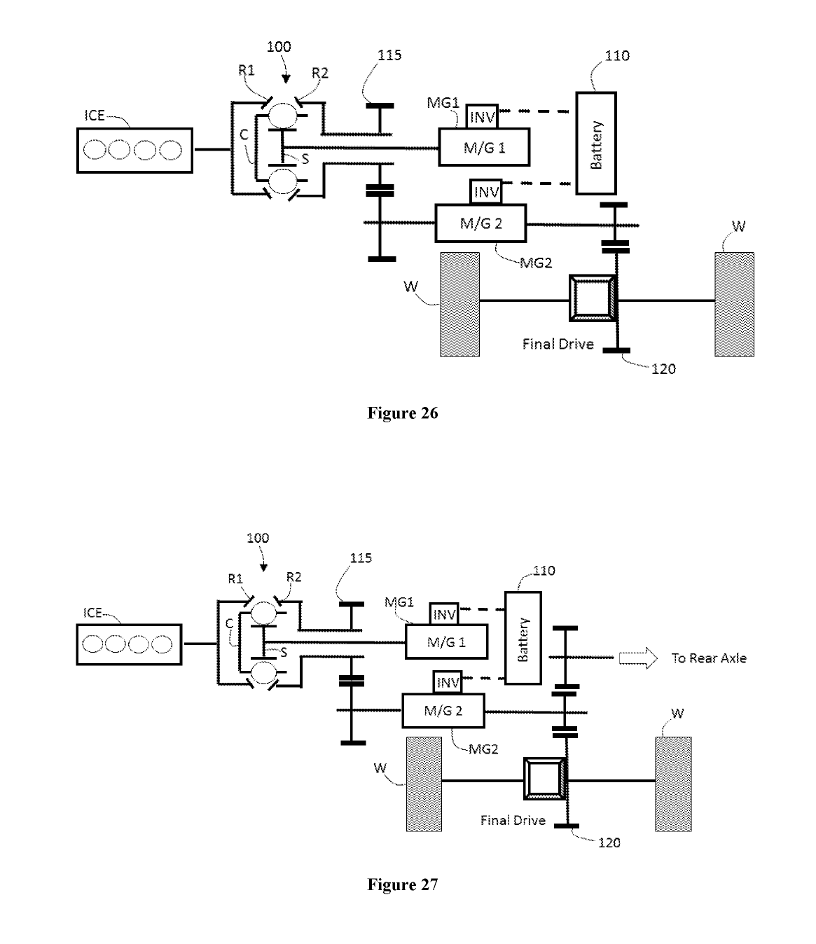

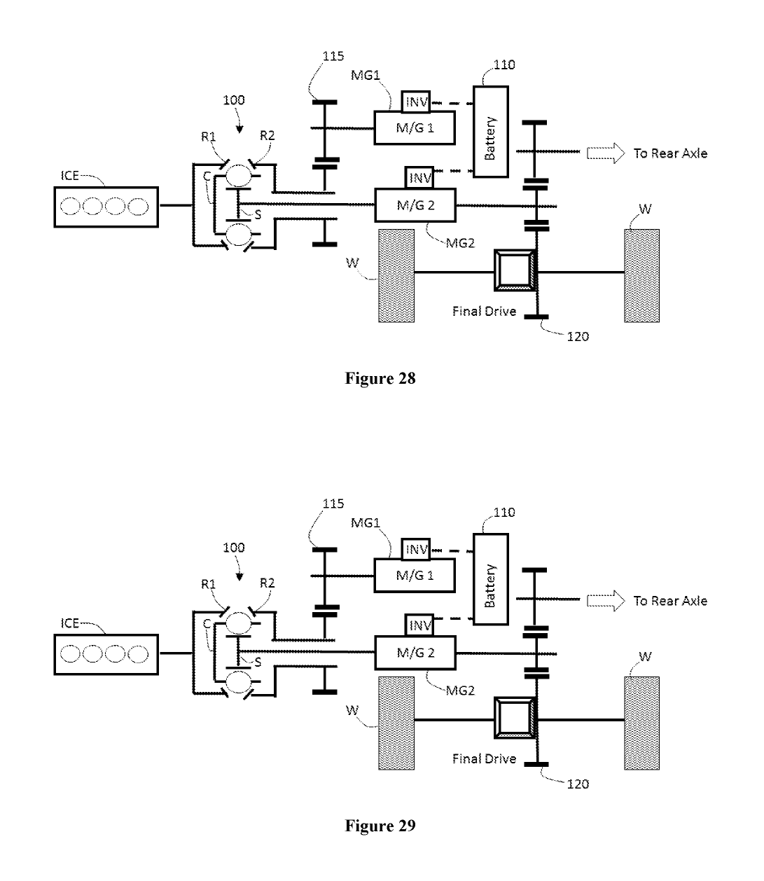

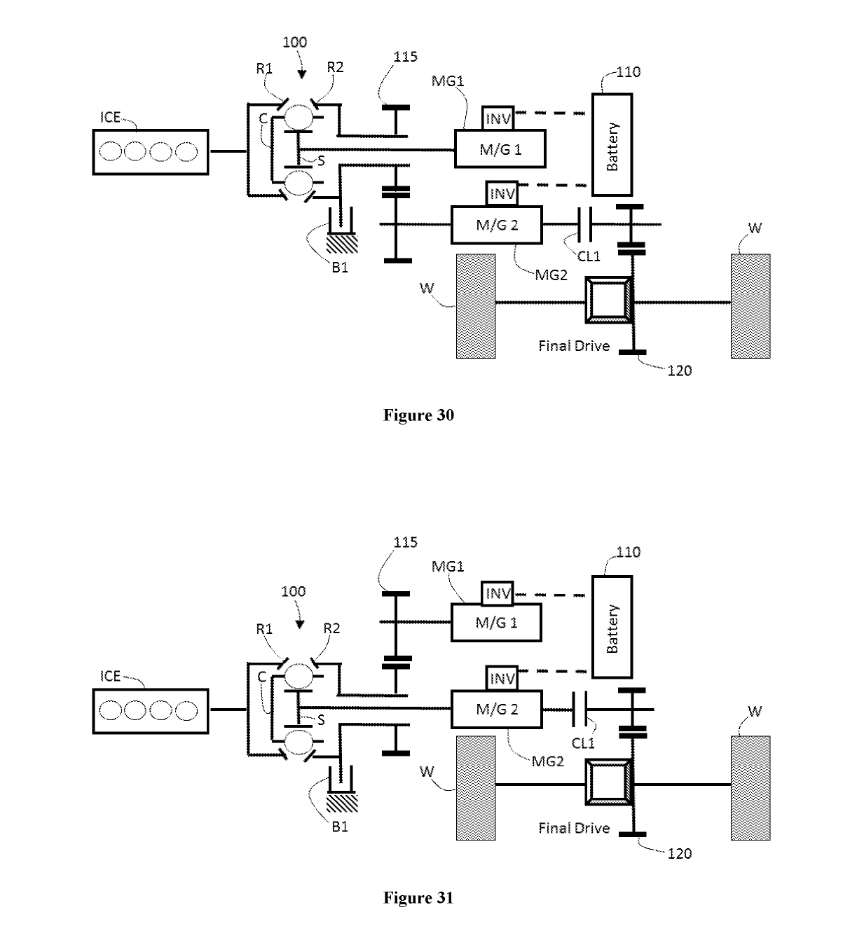

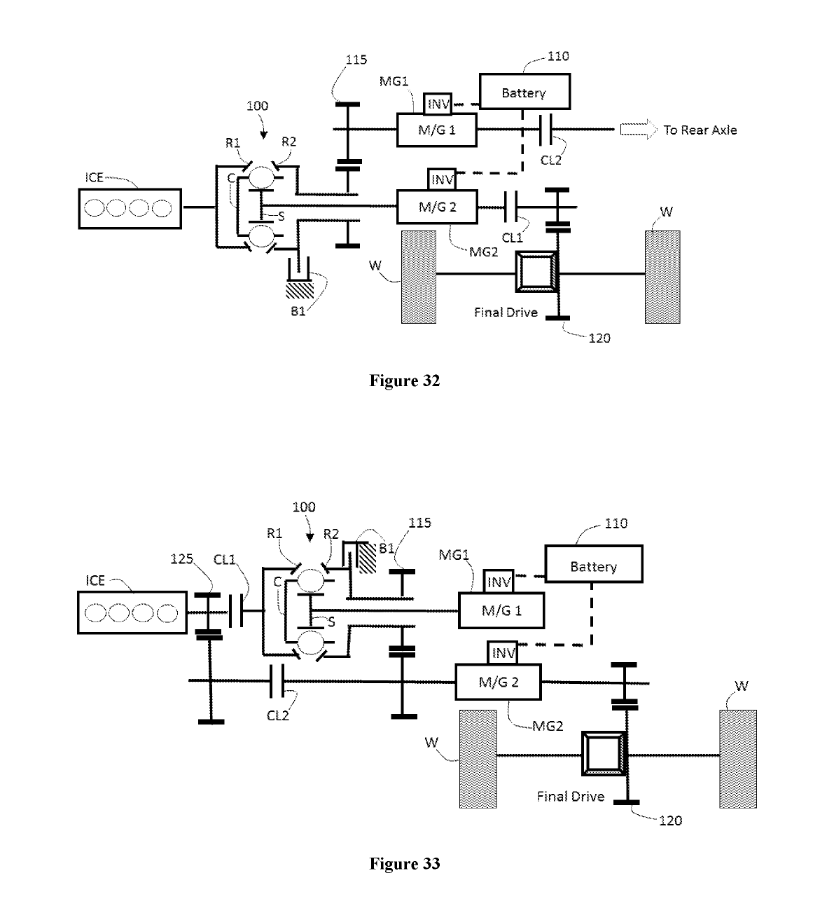

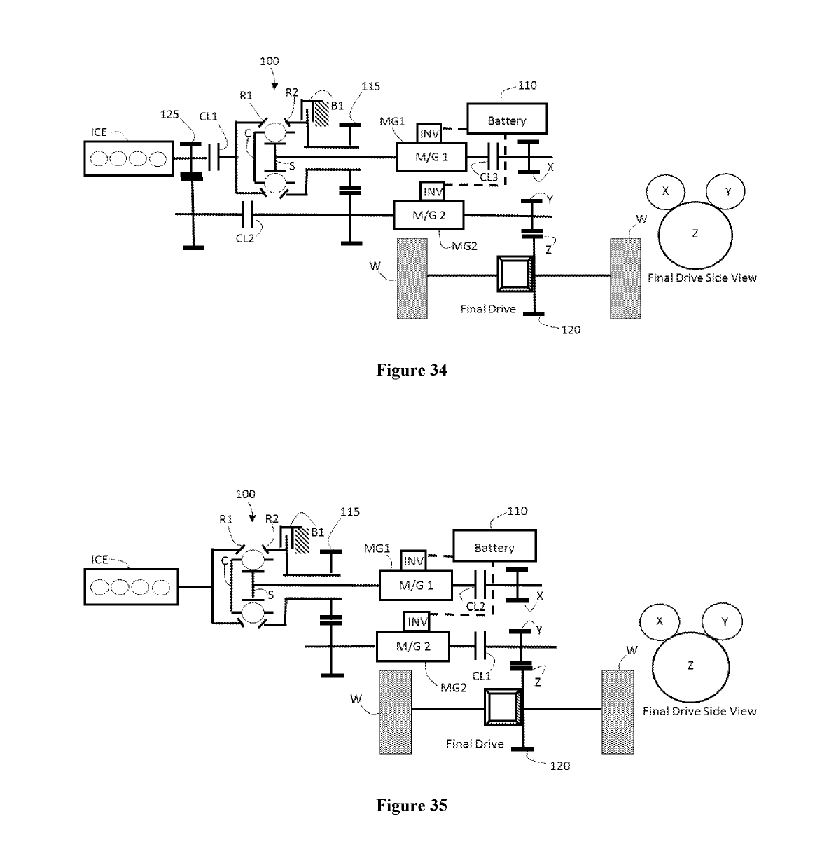

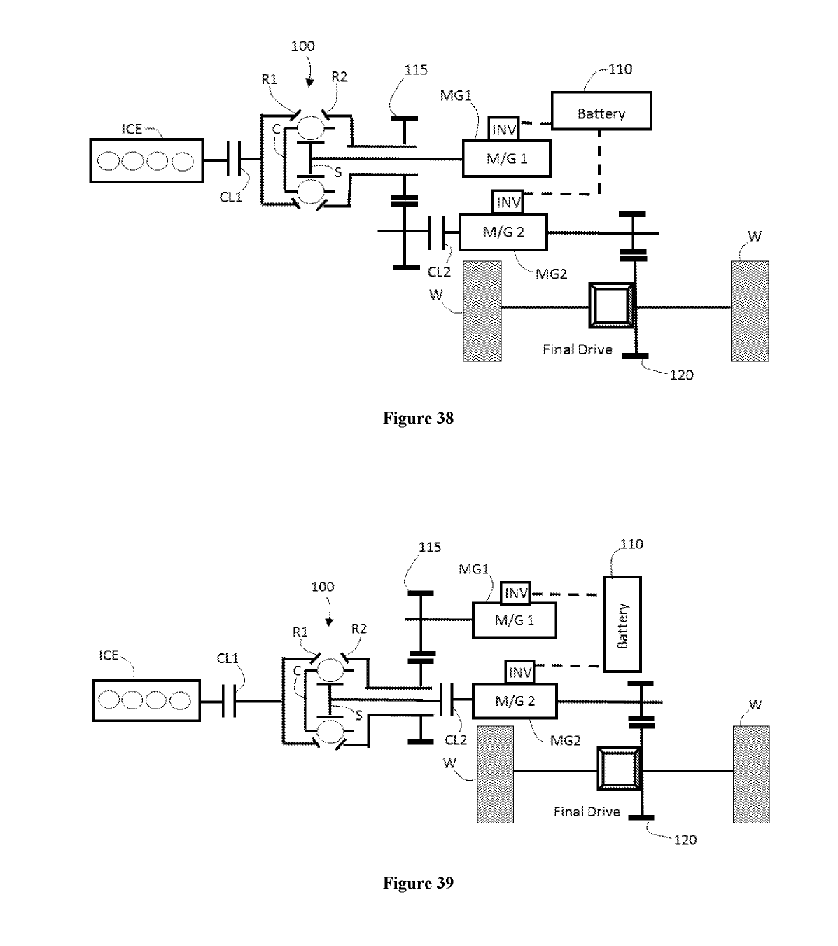

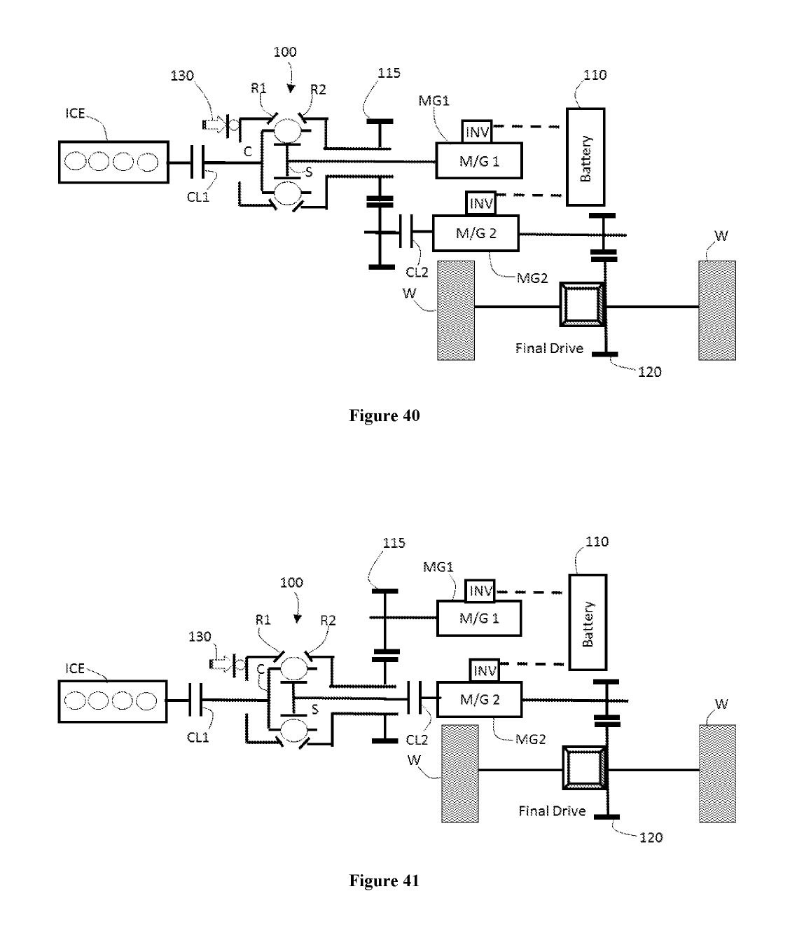

Embodiments disclosed herein are directed to hybrid vehicle powertrain architectures and/or configurations that incorporate a CVP as a power split system in place of a regular planetary leading to a continuously variable power split system where series, parallel or series-parallel, hybrid electric vehicle (HEV) or electric vehicle (EV) modes are obtained. The core element of the power flow is a CVP, which functions as a continuously variable planetary gear split differential with all four of its nodes (R1, R2, C, and S) being variable. As compared to a traditional planetary gear set, the CVP operates with an extra degree of freedom or node. When the variator speed ratio is 1:1, the machine connected to R2 will receive a specific fraction of input torque. In overdrive or underdrive (speed ratio <1) the machine connected to R2 will receive a different fraction of input torque. In some applications, the amount of input torque delivered to R2 is greater than 100% and the system will be regenerative. It should be noted that hydro-mechanical components such as hydromotors, pumps, accumulators, among others, are used in place of the electric machines indicated in the figures and accompanying textual description. Furthermore, it should be noted that embodiments of hybrid architectures disclosed herein incorporate a hybrid supervisory controller that chooses the path of highest efficiency from engine to wheel, leads to the creation of a hybrid powertrain that can operate at the best potential overall efficiency point in any mode and also provide torque variability, thereby leading to the optimal combination of powertrain performance and fuel efficiency. It should be understood that hybrid vehicles incorporating embodiments of the hybrid architectures disclosed herein could include a number of other powertrain components, such as, but not limited to, high-voltage battery pack 110 with a battery management system or ultracapacitor, on-board charger, DC-DC converters, or DC-AC inverters, a variety of sensors, actuators, and controllers, among others. An Inverter (INV), an apparatus that converts direct current into alternating current; is operationally coupled to and a component of each motor/generator. For description purposes, a battery 110 referred to herein and depicted or implied in FIGS. 1-43, is an illustrative example of a battery storage device.

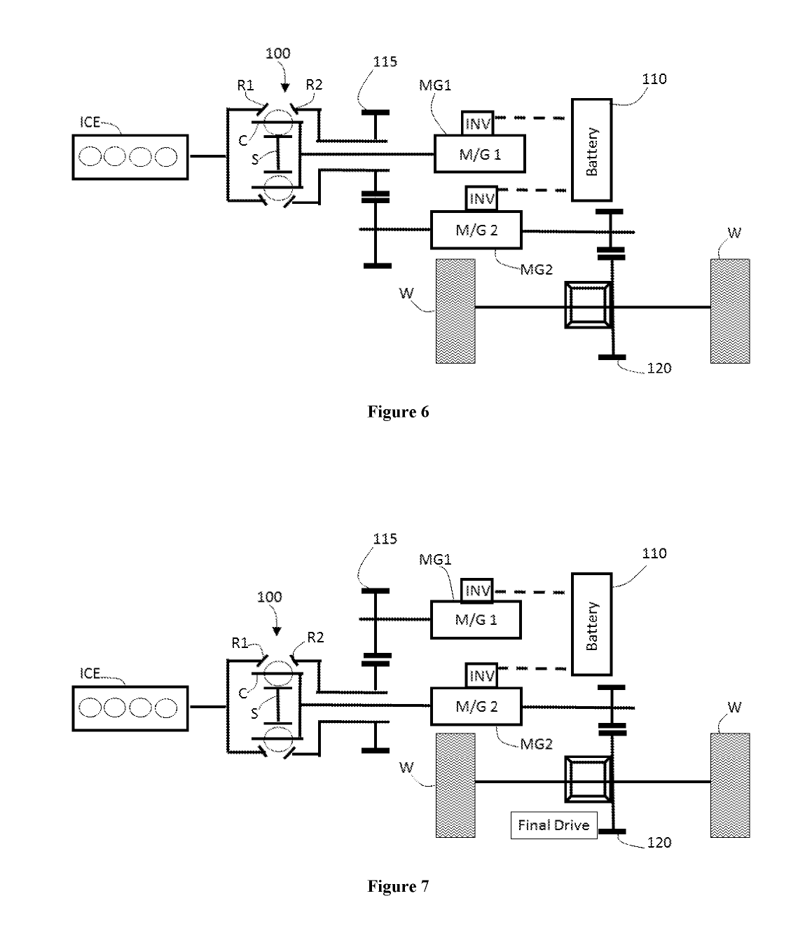

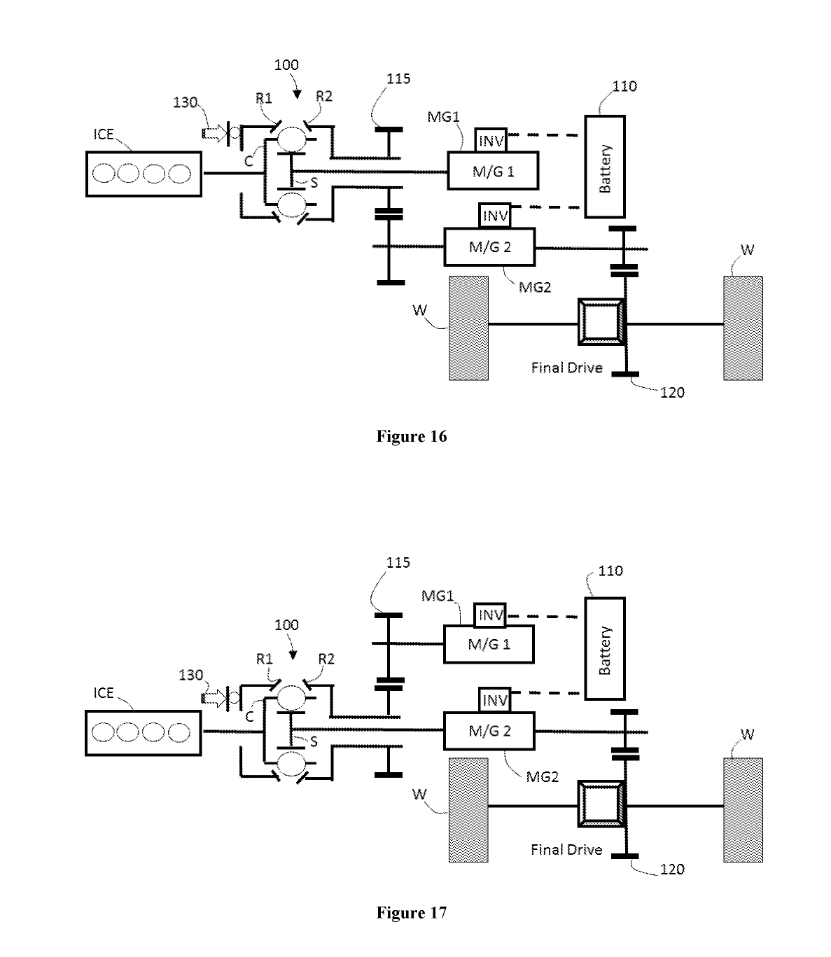

The resulting hybrid powertrain will therefore allow the engine and the electric machines to function in a more efficient operating island leading to the possibility of operating the powertrain in an optimized overall high efficiency mode and at the same time provides the functionality of an electrically variable transmission (EVT/e-CVT) by providing torque variability and a higher overall torque ratio band (ratio band of control system that controls the mode of operation of the HEV powertrain based on a state charge (SOC) of the high voltage battery pack 110. FIGS. 6-15 depict embodiments that are configured to use a variator node (C) as an input to a motor/generator (“MG1 or MG2”) with the sun (S) as a floating element serving as a blended node. FIGS. 16-25 depict embodiments configured to use the sun (S) node as an input to MG1 or MG2 with the first traction ring node (R1) floating as a blended node. The hybrid powertrains described herein include a variator or CVP 100 that is optionally configured as depicted in FIGS. 1-3. In some embodiments, a first transfer gear set 115 is provided to operably couple components of the hybrid powertrains disclosed herein. It should be noted that the first transfer gear set 115 is optionally configured as meshing gears, sprocket and chain couplings, belt and pulley couplings, or any typical mechanical coupling configured to transmit rotational power. Likewise, a second transfer gear set 125 is optionally configured to couple components of the powertrains disclosed herein. It should be appreciated that the first transfer gear 115 and the second transfer gear 125 are shown schematically as meshing gears having a fixed ratio, though one skilled in the art is capable of configuring any number of devices to operably couple the components of the hybrid powertrains disclosed herein. Powertrain configuration provided herein include a final drive gear set 120, sometimes referred to herein as “final drive gearing” or “final drive gear”. It should be appreciated that the final drive gear set 120 is configured to couple to wheels W of a vehicle equipped with the hybrid powertrains disclosed herein. In some embodiments, the final drive gear set 120 includes two or more meshing gears. In some embodiments, the final drive gear set 120 includes a first gear X, a second gear Y, and a third gear Z, each configured to operably couple to components of the powertrain.

Referring now to FIGS. 6, 16, and 26, in some embodiments, hybrid powertrain architectures are configured with a second motor/generator (“MG2” or “M/G 2”) as the primary traction motor and MG1 is the generator. The architecture can sometimes be referred to as series-parallel hybrid powertrain architecture. In some embodiments, the first transfer gear 115 is provided to operably couple the second traction ring R2 to the second motor/generator MG2. The second motor/generator MG2 is operably coupled to the final drive gear set 120.

Turning now to FIGS. 7, 17, and 27, in some embodiments, hybrid powertrain architectures are configured to operably couple the second motor/generator, MG2, to the carrier node (C) or to the sun (S) node, and the first motor/generator, MG1, is coupled to R2 via a step ratio such as the first transfer gear 115. It should be appreciated that a step ratio is depicted schematically herein as meshing gears having a fixed ratio, and is optionally configured with any typical form of mechanical coupling providing a step ratio between rotating components. In some embodiments, the second motor/generator MG2 is operably coupled to the final drive gear set 120.

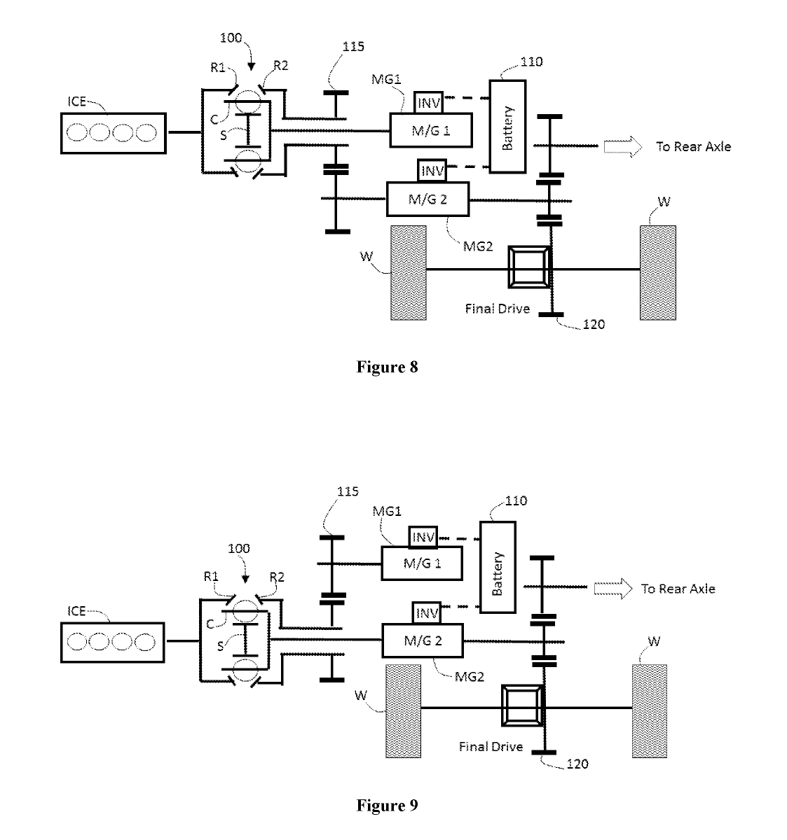

Referring now to FIGS. 8, 9, 18, 19, 28, and 29, in some embodiments, hybrid powertrain architectures can include a gear element configured to provide a four-wheel drive series parallel hybrid. For example, the final drive gear 120 includes meshing gears adapted to transmit rotational power to a front wheel axle and a rear wheel axle. In some embodiments, the first transfer gear set 115 is operably coupled to the second traction ring R2 and the second motor/generator MG2. In some embodiments, the second motor/generator MG2 is operably coupled to the final drive gear 120. In some embodiments, the first transfer gear set 115 is operably coupled to the second traction ring R2 and the first motor/generator MG1.

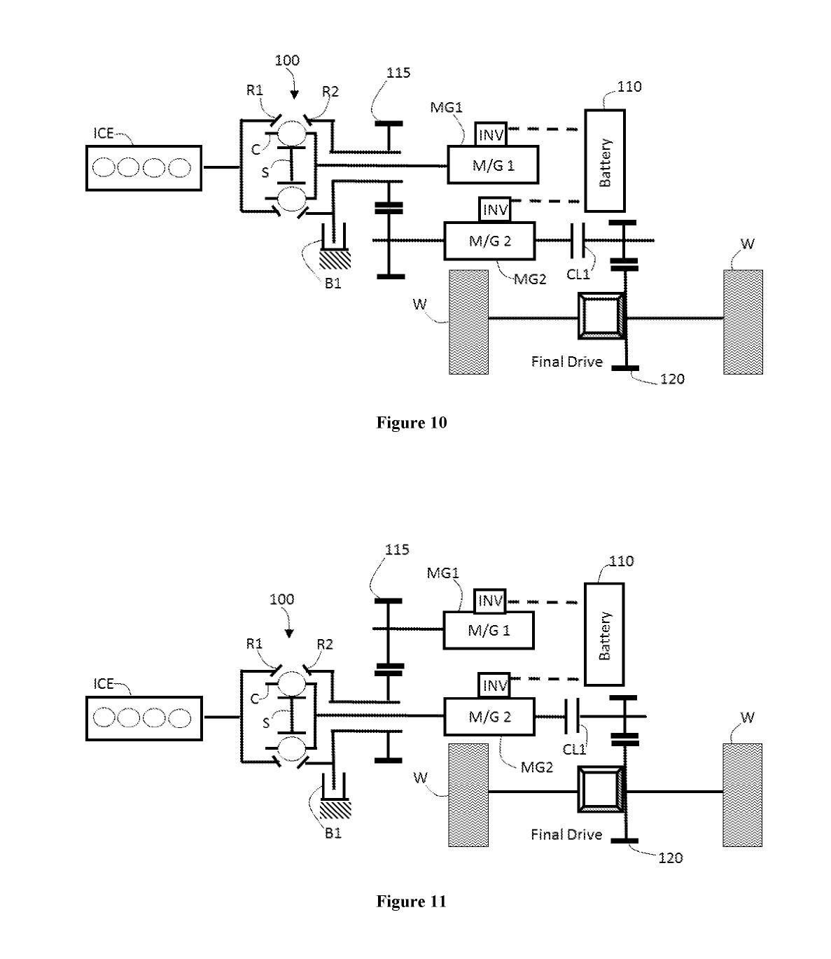

Passing now to FIGS. 10-15, 20-25 and 30-35, in some embodiments, hybrid powertrain architectures include at least one clutch element (referred to in figures with the label “CL1”, “CL2” or “CL3”) arranged before the final drive gear set 120 and adapted to disconnect the HEV powertrain to thereby provide a neutral and a brake condition. These architectures allow the first motor/generator MG1 or the second motor/generator MG2 to be used as an ICE starter motor. In some embodiments, the engine ICE is operably coupled to the first traction ring R1. The second traction ring R2 is operably coupled to the second motor/generator MG2. In some embodiments, the second traction ring R2 is operably coupled to the first motor/generator MG1. In some embodiments, the first transfer gear set 115 is configured to operably couple the second traction ring R2 to one of the first motor/generator MG1 or the second motor/generator MG2. In some embodiments, the first clutch CL1 is operably coupled to the final drive gear set 120 and configured to selectively couple to components of the hybrid powertrain. For example, the first clutch CL1 is operably coupled to the second motor/generator MG2 and the final drive gear set 120.

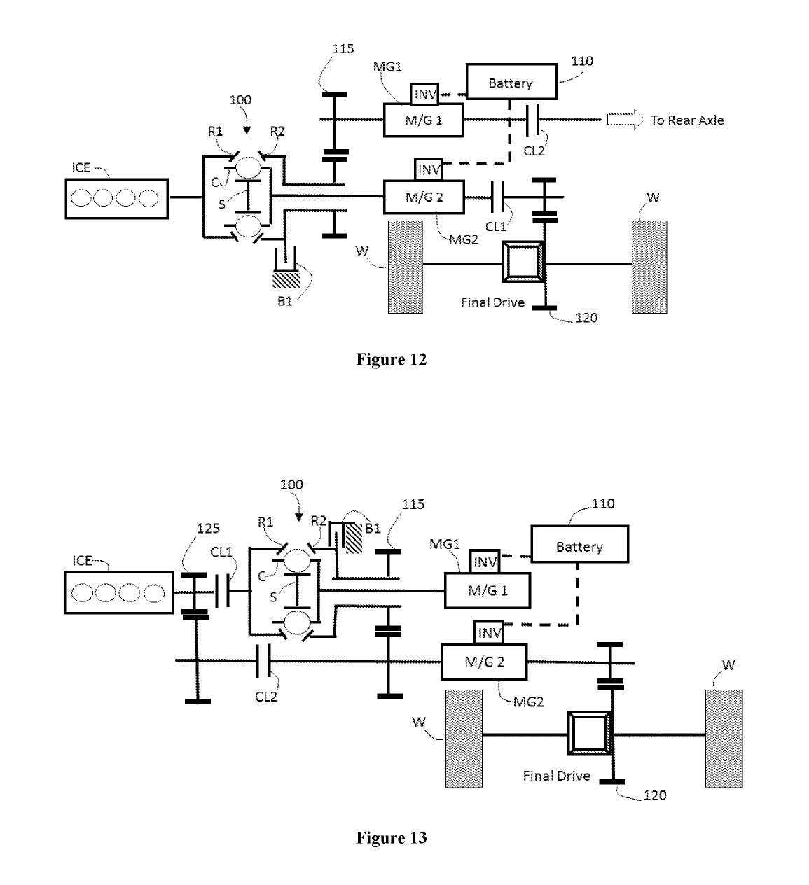

Referring now to FIGS. 12, 22, and 32, in some embodiments, hybrid powertrain architectures are configured with two clutches, the first clutch CL1 and the second clutch CL2, which, when engaged or disengaged gives rise to HEV modes beyond the series-parallel mode. For example, the modes are as follows:
a. The first clutch CL1 and the second clutch CL2 engaged corresponds to a parallel HEV mode with power flow paths via CVP 100 and both motor/generators,
b. The first clutch CL1 disengaged and the second clutch CL2 engaged corresponds to a pure series HEV mode.

Furthermore, having 2 clutches opens up the possibility of an all-wheel drive (“AWD”) configuration and neutral mode. In some embodiments, a brake B1 is operably coupled to the second traction ring R2. The second motor/generator MG2 is operably coupled to the carrier C. In some embodiments, the first transfer gear set 115 is operably coupled to the second traction ring R2 and the first motor/generator MG1.

Turning now to FIGS. 13, 23, and 33, in some embodiments, hybrid powertrain architectures are configured with a parallel torque path around the CVP 100 with a second clutch (labeled in the figures as “CL2”). In some embodiments, the brake B1 is operably coupled to the second traction ring R2. The first motor/generator MG1 is operably coupled to the carrier C. In some embodiments, the first transfer gear set 115 is operably coupled to the second traction ring R2 and the second motor/generator MG2. The second transfer gear set 125 is operably coupled to the engine ICE and the second clutch CL2. In some embodiments, the second motor/generator MG2 is operably coupled to the second clutch CL2.

Referring now to FIGS. 14, 24, and 34, in some embodiments, hybrid powertrain architectures can include three clutches, the first clutch CL1, the second clutch CL2, and a third clutch CL3. In some embodiments, the second clutch CL2 is operably coupled to the second motor/generator MG2 and the engine ICE through the second transfer gear set 125. In some embodiments, the first clutch CL1 is arranged to selectively couple the engine ICE to the first traction ring R1. In some embodiments, the first transfer gear set 115 is operably coupled to the second traction ring R2 and the second motor/generator MG2. The hybrid powertrains depicted in FIGS. 14, 24, and 34 provide a flexible powertrain architecture with the following HEV/EV modes possible:
a. Parallel hybrid mode with one motor when state of charge (“SOC”) of battery system is high corresponds to the second clutch CL2 closed, the first clutch CL1 open, and the third clutch CL3 open.
b. Parallel hybrid mode with two motors when SOC is high corresponds to the second clutch CL2 closed, the first clutch CL1 open, and the third clutch CL3 closed.
c. Series-parallel hybrid mode corresponds to the third clutch CL3 open, the first clutch CL1 and the second clutch CL2 closed.
d. Single motor EV mode corresponds to the first clutch CL1, the second clutch CL2, and the third clutch CL3 open and the second motor/generator MG2 operating as a primary traction motor with no ICE operation.
e. Dual motor EV mode corresponds to the first clutch CL1 and the second clutch CL2 open, the third clutch CL3 closed, and the first motor/generator MG1 and the second motor/generator MG2 operating as traction motors with no ICE operation.
f. Series hybrid mode corresponds to the first clutch CL1 closed, the second clutch CL2 open, the third clutch CL3 open, the first motor/generator MG1 operating as a generator, and the second motor/generator MG2 operating as a traction motor.

Additionally, in FIGS. 14, 24 and 34, there is the option of bypassing the CVP 100 to reduce power losses by opening the first clutch CL1 and the third clutch CL3, while closing the second clutch CL2 to get parallel HEV mode after bypassing the CVP 100. In turn, a neutral mode for the vehicle could be achieved. The directional integrity from engine to wheel for forward motion is maintained by having the gear elements connected to the motor outputs also connected to the final drive element as shown in the figures. Reverse is pure electric vehicle (“EV”) mode with the first clutch CL1 and the second CL2 open and the third clutch CL3 closed.

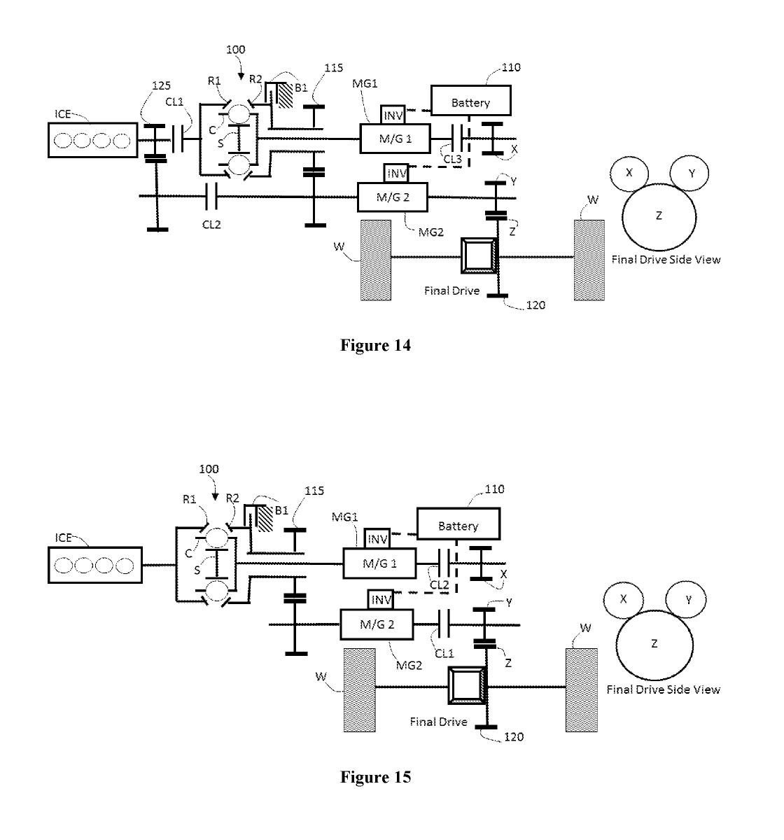

Referring now to FIGS. 15, 25, and 35, in some embodiments, hybrid powertrain architectures are optionally configured that permit switching the motor that is connected to the final drive gear set 120. The directional integrity from engine to wheel for forward motion is maintained by having the gear elements connected to the motor outputs also connected to the final drive element as shown in the figures. In some embodiments, the first motor/generator MG1 is coupled to the carrier C. In some embodiments, the final drive gear set 120 includes a first gear (referred to in text and labeled in figures as “Y”), a second gear (referred to in text and labeled in figures as “X”), and a third gear (referred to in text and labeled in figures as “Z”). The third gear Z is capable of being operably coupled to the wheels W. The second clutch CL2 is configured to selectively couple the first motor/generator MG1 to the first gear X of the final drive gear set 120. The second motor/generator MG2 is operably coupled to the second traction ring R2, for example, with the first transfer gear set 115. In some embodiments, the second clutch CL2 is configured to selectively couple the second motor/generator MG2 to the second gear Y of the final drive gear set 120.

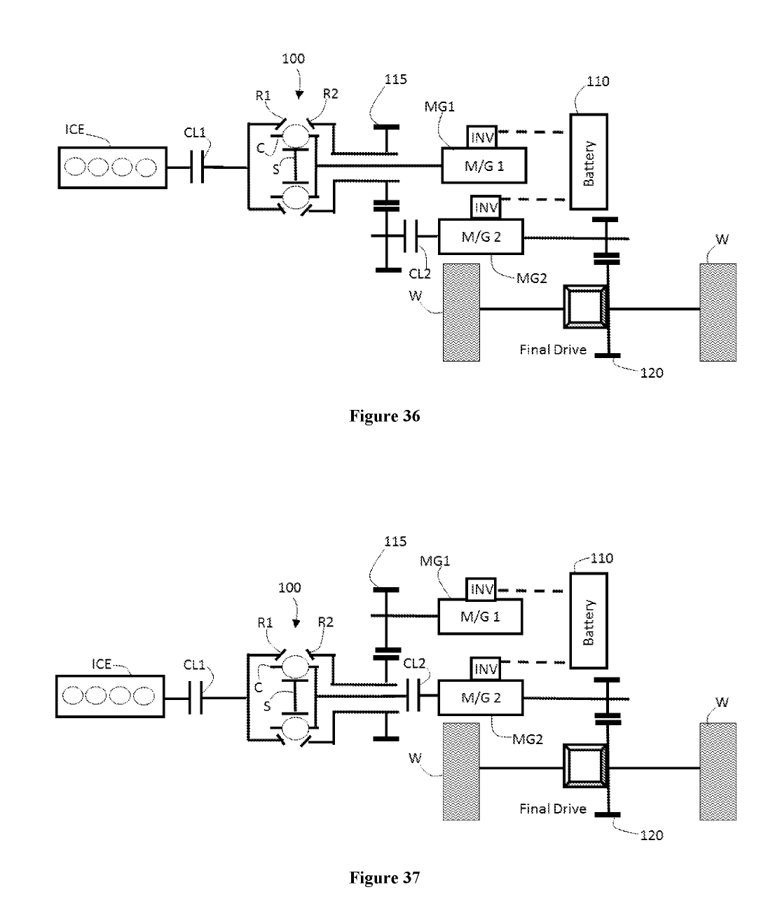

Referring now to FIGS. 36-41, in some embodiments, hybrid powertrain architectures are optionally configured with two clutches where disengaging the second clutch CL2 and engaging the first clutch CL1 provides starter motor capabilities without a braking element. The hybrid modes possible with this system are Single Motor EV, Dual Motor EV, Series HEV, Parallel HEV, and Series Parallel HEV.

As previously discussed, the CVP 100 is used as a splitting differential by connecting three of the four nodes to the ICE, the first motor/generator MG1, the second motor/generator MG2 nodes without grounding the fourth node. Because the first traction ring R1 and the second traction ring R2 are “mirror” functions of each other (for example R1 at overdrive behaves like R2 at underdrive), there are only six (not eight) configurations for a splitting differential that is not regenerative. Each powertrain configuration or architecture has its own specific torque split range for the first motor/generator MG1 versus the second motor/generator MG2, and the efficiency of the CVP 100 used as a splitting differential is different from one configuration to another. For example, the following configurations and torque ranges are configured:
a. The first traction ring R1 is connected to the engine ICE, the second traction ring R2 is connected to the first motor/generator MG1, the carrier C is connected to the second motor/generator MG2. In some embodiments, the first transfer gear set 115 coupled the first motor/generator MG1 to the second traction ring R2. In some embodiments, the torque on the first motor/generator MG1 is variable from 50% to 100% of engine torque.
b. The first traction ring R1 is connected to the ICE, the second traction ring R2 is connected to the second motor/generator MG2, the carrier C is connected to the first motor/generator MG1. In some embodiments, the first transfer gear set 115 coupled the second motor/generator MG2 to the second traction ring R2. In some embodiments, the torque on the first motor/generator MG1 is variable from 0% to 50% of the engine torque.
c. The first traction ring R1 is connected to the ICE, the second traction ring R2 is connected to the second motor/generator MG2, the sun S is connected to the first motor/generator MG1. In some embodiments, the first transfer gear set 115 coupled the second motor/generator MG2 to the second traction ring R2. In some embodiments, the torque on the first motor/generator MG1 is variable from about 67% to about 81% of the engine torque.
d. The first traction ring R1 is connected to the ICE, the second traction ring R2 is connected to the first motor/generator MG1, the sun S is connected to the second motor/generator MG2. In some embodiments, the first transfer gear set 115 coupled the first motor/generator MG1 to the second traction ring R2. In some embodiments, the torque on the first motor/generator MG1 is variable from 19% to 33% of the engine torque.
e. The carrier C is connected to the ICE, the second traction ring R2 is connected to the first motor/generator MG1, the sun S is connected to the second motor/generator MG2. In some embodiments, the first transfer gear set 115 coupled the first motor/generator MG1 to the second traction ring R2. In some embodiments, the torque on the first motor/generator MG1 is variable from 81% to 100% of the engine torque.
f. The carrier C is connected to the ICE, the second traction ring R2 is connected to the first motor/generator MG1, the sun S is connected to the first motor/generator MG1. In some embodiments, the first transfer gear set 115 coupled the first motor/generator MG1 to the second traction ring R2. In some embodiments, the torque on the first motor/generator MG1 is variable from 0%-19% of the engine torque.

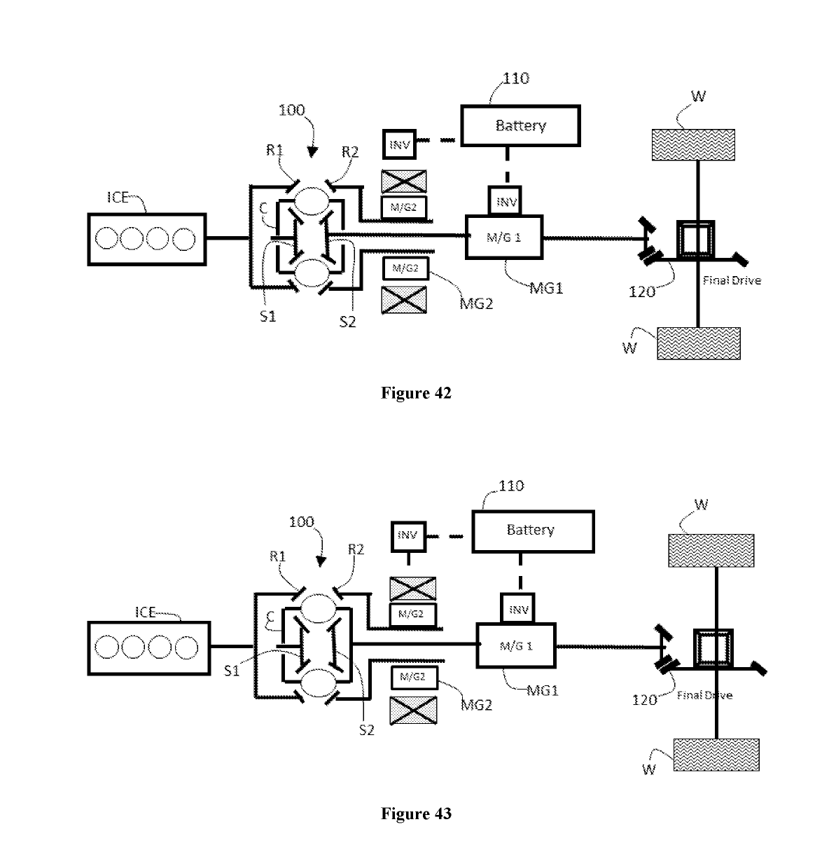

Referring now to FIGS. 42 and 43, in some embodiments, hybrid powertrain architectures are optionally configured to have a coaxial arrangement suitable for rear wheel drive vehicles. For example, the ICE is coaxial with the variator and the motor/generators. Referring to FIG. 42, the engine ICE is operably coupled to the first traction ring R1, the second motor/generator MG2 is operably coupled to the second traction ring R2, and the first motor/generator MG1 is operably coupled to the sun S (sometimes referred to as “node S” or “S”). In some embodiments, the sun assembly includes two sun elements depicted in FIGS. 42 and 43 as “S1” and “S2”. It should be appreciated that “S1” and “S2” are collectively referred to as the sun node “S”. Referring to FIG. 43, the ICE is operably coupled to the first traction ring R1, the second motor/generator MG2 is operably coupled to the second traction R2, and the first motor/generator MG1 is operably coupled to the carrier assembly C (sometimes referred to as “node C” or “C”). The first motor/generator MG1 is operably coupled to the drive wheels of a vehicle through the final drive gear set 120.

For some embodiments having the ICE connected to the carrier C, a ball-ramp actuator 130 load is depicted, as in FIG. 41. For CVP designs that use two ball-ramp clamping force generators, one of which is loaded, the load is transmitted to the other via the CVP ball. In some of the embodiments described herein, the ball-ramp actuator 130 is not necessary. The ball-ramp actuator 130 covers the case when there is a single ball-ramp clamping force generator or if there is insufficient load on the second ball-ramp.

Provided herein is a powertrain having one motor/generator MG1; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C operably coupled to a shift actuator; wherein the source of rotational power ICE is operably coupled to the first traction ring R1; wherein the sun S is adapted to rotate freely; and wherein the first motor/generator MG1 is operably coupled to the second traction ring R2. In some embodiments of the powertrain, the carrier C is operably coupled to a second motor/generator MG2. In some embodiments of the powertrain, a brake B1 is operably coupled to the second traction ring R2. In some embodiments of the powertrain, a first clutch CL1 is operably coupled to the second motor/generator MG2. In some embodiments of the powertrain, a first clutch CL1 is operably coupled to the second motor/generator MG2, and a second clutch CL2 is operably coupled to the first motor/generator MG1. In some embodiments of the powertrain, a first clutch CL1 is operably coupled to the first traction ring R2, a second clutch CL2 is operably coupled to the second motor/generator MG2, and a third clutch CL3 is operably coupled to the first motor/generator MG1. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: a first motor/generator MG1; a second motor/generator MG2; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each balls operably coupled to a carrier C, the carrier C operably coupled to a shift actuator; wherein the source of rotational power ICE is operably coupled to the carrier C; wherein the first traction ring R1 is adapted to rotate freely; and wherein the first motor/generator MG1 is operably coupled to the second traction ring R2. In some embodiments of the powertrain, the sun S is operably coupled to the second motor/generator MG2. In some embodiments of the powertrain, a brake B1 is operably coupled to the second traction ring R2. In some embodiments of the powertrain, a first clutch CL1 is operably coupled to the second motor/generator MG2. In some embodiments of the powertrain, a first clutch CL1 is operably coupled to the second motor/generator MG2, and a second clutch CL2 operably coupled to the first motor/generator MG1. In some embodiments of the powertrain, a first clutch CL1 is operably coupled to the first traction ring R1, a second clutch CL2 is operably coupled to the second motor/generator MG2, and a third clutch CL3 operably coupled to the first motor/generator MG1. In some embodiments of the powertrain, a ball-ramp actuator 130 is operably coupled to the first traction ring R1. In some embodiments of the powertrain, a first clutch CL1 is operably coupled to the first traction ring R1, a second clutch CL2 is operably coupled to the second motor/generator MG1, and a third clutch CL3 is operably coupled to the first motor/generator MG1. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: a first motor/generator MG1; a second motor/generator MG2; a source of rotational power ICE; a continuously variable planetary transmission (CVP) 100 having a plurality of balls, each ball provided with a tiltable axis of rotations, each ball in contact with a first traction ring R1 and a second traction ring R2, each ball in contact with a sun S, the sun S located radially inward of each ball, and each balls operably coupled to a carrier C, the carrier C is operably coupled to a shift actuator; wherein the source of rotational power ICE is operably coupled to the first traction ring R1; wherein the carrier C is adapted to rotate freely; and wherein the first motor/generator MG1 is operably coupled to the sun S. In some embodiments of the powertrain, the second traction ring R2 is operably coupled to the second motor/generator MG2. In some embodiments of the powertrain, a brake B1 operably is coupled to the second traction ring R2. In some embodiments of the powertrain, a first clutch CL1 is operably coupled to the second motor/generator MG2. In some embodiments of the powertrain, a first clutch CL1 is operably coupled to the second motor/generator MG2, and a second clutch CL2 operably coupled to the first motor/generator MG1. In some embodiments of the powertrain, a first clutch CL1 is operably coupled to the first traction ring R1, a second clutch CL2 operably coupled to the second motor/generator MG2, and a third clutch CL3 operably coupled to the first motor/generator MG1. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: at least one hydro-mechanical component; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C is operably coupled to a shift actuator; wherein the source of rotational power ICE is operably coupled to the first traction ring R1; wherein the sun S is adapted to rotate freely; and wherein the hydro-mechanical component is operably coupled to the second traction ring R2. In some embodiments of the powertrain, the carrier C is operably coupled to a second hydro-mechanical component. In some embodiments of the powertrain, a brake B1 is operably coupled to the second traction ring R2. In some embodiments of the powertrain, a first clutch CL1 is operably coupled to the second hydro-mechanical component. In some embodiments of the powertrain, a first clutch CL1 is operably coupled to the second hydro-mechanical component, and a second clutch CL2 operably coupled to the hydro-mechanical component. In some embodiments of the powertrain, a first clutch CL1 operably is coupled to the first traction ring R1, a second clutch CL2 is operably coupled to the second hydro-mechanical component, and a third clutch CL3 operably coupled to the first hydro-mechanical component. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain comprising: a first motor/generator MG1; a second motor/generator MG2; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C operably coupled to a shift actuator; wherein the source of rotational power ICE is operably coupled to the first traction ring R1; wherein the carrier C is adapted to rotate freely; wherein the first motor/generator MG1 is operably coupled to the sun S; and wherein the second motor/generator MG2 is operably coupled to the second traction ring R2; and wherein the CVP 100, the first motor/generator MG1, the second motor/generator MG2, and the source of rotational power ICE are coaxial.

Provided herein is a powertrain comprising: a first motor/generator MG1; a second motor/generator MG2; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C is operably coupled to a shift actuator; wherein the source of rotational power ICE is operably coupled to the first traction ring R1; wherein the carrier C is adapted to rotate; wherein the first motor/generator MG1 is operably coupled to the carrier C; and wherein the second motor/generator MG2 is operably coupled to the second traction ring R2; and wherein the CVP 100, the first motor/generator MG1, the second motor/generator MG2, and the source of rotational power ICE are coaxial.

It should be noted that where an ICE is described, the ICE is an internal combustion engine (diesel, gasoline, hydrogen) or any powerplant such as a fuel cell system, or any hydraulic/pneumatic powerplant like an air-hybrid system. Along the same lines, the battery 110 is not just a high voltage pack such as lithium ion or lead-acid batteries, but also ultracapacitors or other pneumatic/hydraulic systems such as accumulators, or other forms of energy storage systems. MG1 and MG2 can represent hydromotors actuated by variable displacement pumps, electric machines, or any other form of rotary power such as pneumatic motors driven by pneumatic pumps. The eCVT architectures depicted in the figures and described in text is extended to create a hydro-mechanical CVT architectures as well for hydraulic hybrid systems. It should be appreciated that the hybrid architectures disclosed herein could also include additional clutches, brakes, and couplings to three nodes of the CVP 100.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Various embodiments as described herein are provided in the Aspects below:
Aspect 1: A powertrain comprising:
   a first motor/generator;
   a second motor/generator;
   a source of rotational power;
   a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator;
   wherein the source of rotational power is operably coupled to the carrier;
   wherein the first traction ring is adapted to rotate freely; and
   wherein the first motor/generator is operably coupled to the second traction ring.
Aspect 2: The powertrain of Aspect 1, wherein the sun is operably coupled to the second motor/generator.
Aspect 3: The powertrain of Aspect 2, further comprising a brake operably coupled to the second traction ring.
Aspect 4: The powertrain of Aspect 2, further comprising a first clutch operably coupled to the second motor/generator.
Aspect 5: The powertrain of Aspect 2, further comprising a first clutch operably coupled to the second motor/generator, and a second clutch operably coupled to the first motor/generator.
Aspect 6: The powertrain of Aspect 3, further comprising a first clutch operably coupled to the first traction ring, a second clutch operably coupled to the second motor/generator, and a third clutch operably coupled to the first motor/generator.
Aspect 7: The powertrain of Aspect 1, further comprising a ball-ramp actuator operably coupled to the first traction ring.
Aspect 8: The powertrain of Aspect 1, further comprising a powertrain supervisory controller, said controller capable of supplying control signals to all components of the powertrain such that the said controller is capable of dynamically affecting a plurality of operating modes.
Aspect 9: A powertrain comprising:
   a first motor/generator;
   a second motor/generator;
   a source of rotational power;
   a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator;
   wherein the source of rotational power is operably coupled to the first traction ring;
   wherein the carrier is adapted to rotate freely; and
   wherein the first motor/generator is operably coupled to the sun.
Aspect 10: The powertrain of Aspect 9, wherein the second traction ring is operably coupled to the second motor/generator.
Aspect 11: The powertrain of Aspect 10, further comprising a brake operably coupled to the second traction ring.
Aspect 12: The powertrain of Aspect 10, further comprising a first clutch operably coupled to the second motor/generator.
Aspect 13: The powertrain of Aspect 10, further comprising a first clutch operably coupled to the second motor/generator, and a second clutch operably coupled to the first motor/generator.
Aspect 14: The powertrain of Aspect 11, further comprising a first clutch operably coupled to the first traction ring, a second clutch operably coupled to the second motor/generator, and a third clutch operably coupled to the first motor/generator.
Aspect 15: The powertrain of Aspect 9, further comprising a ball-ramp actuator operably coupled to the first traction ring.
Aspect 16: The powertrain of Aspect 9, further comprising a powertrain supervisory controller, said controller capable of supplying control signals to all components of the powertrain such that the said controller is capable of dynamically affecting a plurality of operating modes.
Aspect 17: A powertrain comprising:
   a first hydro-mechanical component;
   a source of rotational power;
   a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator;
   wherein the source of rotational power is operably coupled to the first traction ring;
   wherein the sun is adapted to rotate freely; and
   wherein the first hydro-mechanical component is operably coupled to the second traction ring.
Aspect 18: The powertrain of Aspect 17, wherein the carrier is operably coupled to a second hydro-mechanical component.
Aspect 19: The powertrain of Aspect 18, further comprising a brake operably coupled to the second traction ring.
Aspect 20: The powertrain of Aspect 18, further comprising a first clutch operably coupled to the second hydro-mechanical component.
Aspect 21: The powertrain of Aspect 18, further comprising a first clutch operably coupled to the second hydro-mechanical component, and a second clutch operably coupled to the hydro-mechanical component.
Aspect 22: The powertrain of Aspect 19, further comprising a first clutch operably coupled to the first traction ring, a second clutch operably coupled to the second hydro-mechanical component, and a third clutch operably coupled to the first hydro-mechanical component.
Aspect 23: The powertrain of Aspect 17, further comprising a ball-ramp actuator operably coupled to the first traction ring.
Aspect 24: The powertrain of Aspect 17, further comprising a powertrain supervisory controller, said controller capable of supplying control signals to all components of the powertrain such that the said controller is capable of dynamically affecting a plurality of operating modes.
Aspect 25: A powertrain comprising:
   a first motor/generator;
   a second motor/generator;
   a source of rotational power;
   a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator;
   wherein the source of rotational power is operably coupled to the first traction ring;
   wherein the carrier is adapted to rotate freely;
   wherein the first motor/generator is operably coupled to the sun; and
   wherein the second motor/generator is operably coupled to the second traction ring; and
   wherein the CVP, the first motor/generator, the second motor/generator, and the source of rotational power are coaxial.
Aspect 26: A powertrain comprising:
   a first motor/generator;
   a second motor/generator;
   a source of rotational power;
   a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator;
   wherein the source of rotational power is operably coupled to the first traction ring;
   wherein the carrier is adapted to rotate;
   wherein the first motor/generator is operably coupled to the carrier; and
   wherein the second motor/generator is operably coupled to the second traction ring; and
   wherein the CVP, the first motor/generator, the second motor/generator, and the source of rotational power are coaxial.

1-8. (canceled)

9. A powertrain comprising:
a first motor/generator;
a second/motor generator;
a source of rotational power; and
a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator,
wherein the source of rotational power is operably coupled to the carrier,
wherein the first traction ring is adapted to rotate freely, and
wherein the second motor/generator is operably coupled to the second traction ring.

10. The powertrain of claim 9, wherein the sun is operably coupled to the first motor/generator.

11. The powertrain of claim 9 further comprising a brake operably coupled to the second traction ring.

12. The powertrain of claim 9 further comprising a first clutch operably coupled to the second motor/generator.

13. The powertrain of claim 9 further comprising a first clutch operably coupled to the source of rotational power, and a second clutch operably coupled to the second motor/generator.

14. The powertrain of claim 8 further comprising a ball-ramp actuator operably coupled to the first traction ring.

15. A powertrain comprising:
a first motor/generator;
a second/motor generator;
a source of rotational power; and
a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator,
wherein the source of rotational power is operably coupled to the first traction ring,
wherein the carrier is adapted to rotate freely, and
wherein the first motor/generator is operably coupled to the sun.

16. The powertrain of claim 15, wherein the second traction ring is operably coupled to the second motor/generator.

17. The powertrain of claim 15 further comprising a brake operably coupled to the second traction ring.

18. The powertrain of claim 15 further comprising a first clutch operably coupled to the second motor/generator.

19. The powertrain of claim 15 further comprising a first clutch operably coupled to the source of rotational power, and a second clutch operably coupled to the second motor/generator.

20. The powertrain of claim 15 further comprising a first clutch operably coupled to the source of rotational power, and a second clutch operably coupled to the first motor/generator.

21. The powertrain of claim 7 further comprising a first clutch operably coupled to the first traction ring, a second clutch operably coupled to the second motor/generator, and a third clutch operably coupled to the first motor/generator.

22. A powertrain comprising:
a first motor/generator;
a source of rotational power; and
a continuously variable planetary transmission (CVP) having a plurality of balls, each ball provided with a tiltable axis of rotation, each ball in contact with a first traction ring and a second traction ring, each ball in contact with a sun, the sun located radially inward of each ball, and each ball operably coupled to a carrier, the carrier operably coupled to a shift actuator,
wherein the source of rotational power is operably coupled to the first traction ring,
wherein the sun is adapted to rotate freely, and
wherein the first motor/generator is operably coupled to the second traction ring.

23. The powertrain of claim 22, wherein the carrier is operably coupled to a second motor/generator.

24. The powertrain of claim 22 further comprising a brake operably coupled to the second traction ring.

25. The powertrain of claim 22 further comprising a first clutch operably coupled to the second motor/generator.

26. The powertrain of claim 22 further comprising a first clutch operably coupled to the second motor/generator, and a second clutch operably coupled to the first motor/generator.

27. The powertrain of claim 23 further comprising a first clutch operably coupled to the first traction ring, a second clutch operably coupled to the second motor/generator, and a third clutch operably coupled to the first motor/generator.
